(19) United States
(12) Patent Application Publication
(10) Pub. No.: US 2003/0046367 A1
(43) Pub. Date: Mar. 6, 2003

(54) Digital contents distribution system and digital contents distribution method

(75) Inventor: Nobuyuki Tanaka, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/227,798

(22) Filed: Aug. 27, 2002

(30) Foreign Application Priority Data
Aug. 31, 2001 (JP) 262995/2001

(51) Int. Cl. G06F 15/16; H04L 9/00; H04K 1/00; G06F 17/60; H04H 9/00; H04N 7/16

(52) U.S. Cl. 709/219; 705/51; 705/14; 725/9

(57) ABSTRACT

A digital contents distribution system according to the present invention includes a contents server that distributes contents composed of a plurality of scenes or a plurality of chapters to a client terminal, the client terminal that reproduces the contents, and a management server that controls the contents server. The contents server embeds digital watermarks into the plurality of scenes and the plurality of chapters, the digital watermarks differing from scene to scene or from chapter to chapter. The client terminal detects and records the digital watermarks embedded in the digital contents while the digital contents are being reproduced. The management server references the digital watermarks recorded by the client terminal to control the contents server.

### BACKGROUND OF THE INVENTION

Field of the Invention

The present invention relates to a system and a method for distributing digital contents composed of audio data and video data.

A digital contents distribution system comprises a contents server that distributes digital contents, composed of audio data and video data, to client terminals over a network and client terminals (PC and so on) that reproduce distributed digital contents.

A client terminal contains a digital contents data reproducer. As shown in FIG. 1, the digital contents data reproducer comprises digital contents data 41, an AV (Audio Video) separator 42, an audio decoder 43, an audio output apparatus 44, a speaker 45, a video decoder 46, a video display 47, and a display screen 48.

The digital contents data 41 is separated by the AV separator 42 into audio data and video data. Audio data separated by the AV separator 42 is decoded by the audio decoder 43. The audio output apparatus 44 outputs decoded audio data to the speaker 45. On the other hand, video data separated by the AV separator 42 is decoded by the video decoder 46. The video display 47 displays the decoded video data on the display screen 48.

The digital contents data reproducer is an apparatus that reproduces, in real time, digital contents distributed by a server. While a reproduction instruction is active, the digital contents data reproducer reproduces digital contents while keeping on downloading digital contents from the server. In response to a reproduction suspension instruction from a user during digital contents reproduction, the digital contents data reproducer suspends digital contents downloading and, at the same time, stops digital contents reproduction. In response to a digital contents reproduction instruction from a user while digital contents reproduction is being suspended, the digital contents data reproducer starts downloading the remaining digital contents (digital contents not yet reproduced) and reproduces the digital contents. To restart digital contents reproduction after a suspension, the digital contents data reproducer must measure to which point the digital contents have been reproduced and notify the user of the measured value. Conventionally, the digital contents data reproducer has measured the reproduction time to the suspension and notifies the server of the measured value. However, because digital contents are composed of multiple chapters each including multiple scenes, the digital contents data reproducer simply need to notify the server what scenes and what chapters have been reproduced. This information allows the server to correctly distribute the digital contents beginning with the next scene or the next chapter, that is, the first scene or the first chapter of the digital contents not yet reproduced.

### SUMMARY OF THE INVENTION

It is an object of the present invention to provides a digital contents distribution system and a digital contents distribution method that precisely trace the reproduction status of digital contents without having to measure digital contents reproduction times.

As more and more medium data is digitized recently, creating illegal copies of digitized data has become a big problem. A digital watermark embedding/detection technology, one of technologies for preventing illegal copies, has attracted attention and is now being studied for practical use. Digital watermarks are characterized in that they cannot be altered easily by the user and that they are contained in digital contents semi-permanently. The system and the method according to the present invention are used not only for preventing illegal copies, which is the primary purpose of digital watermarks, but also for tracing the reproduction status of digital contents.

The digital contents distribution system according to the present invention comprises a contents server that distributes digital contents composed of a plurality of chapters each containing a plurality of scenes to a client terminal, a client PC that reproduces the digital contents, and a management server that manages the reproduction status of the digital contents on the client PC. The contents server, the client PC, and the management server are connected via a network. While the digital contents are being reproduced, the client PC detects digital watermarks embedded in the digital contents and stores the detected digital watermarks. When the client PC stops and then later restarts reproduction, the digital watermarks detected when the reproduction stopped are sent to the management server. The management server checks the digital watermarks to find to which scene or chapter the client PC has reproduced the digital contents. The management server instructs the contents server to distribute the digital contents beginning with the next scene or the next chapter.

When creating a data stream, the digital contents distribution system according to the present invention embeds digital watermarks into the scenes and chapters of the original image composed of a plurality of chapters each including a plurality of scenes and then uses an MPEG (Moving Picture Experts Group) encoder to MPEG-encode the digital contents.

### BRIEF DESCRIPTION OF THE DRAWINGS

FIG. 1 is a block diagram showing the configuration of a conventional digital contents data reproducer;

FIG. 2 is a block diagram showing the configuration of a digital watermark embedding apparatus;

FIG. 3 is a diagram showing the configuration of a stream;

FIG. 4 is a block diagram showing the configuration of a digital contents data reproducer;

FIG. 5 is a block diagram showing a streaming distribution system;

FIG. 6 is a sequence diagram showing the operation of the streaming distribution system; and

FIG. 7 is a block diagram showing a digital contents distribution system.

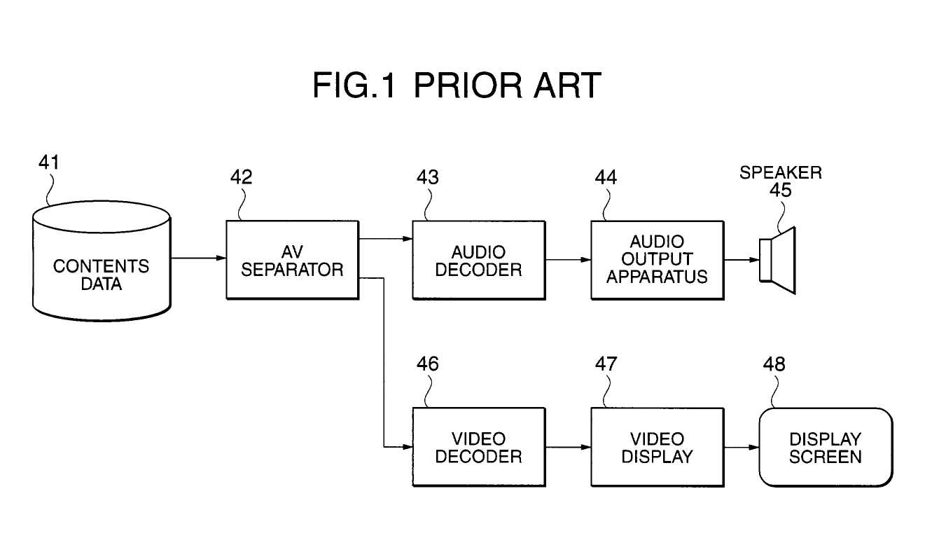

### DETAILED DESCRIPTION OF THE PREFERRED EMBODIMENTS

Next, some embodiments of the present invention will be described in detail by referring to the attached drawings.

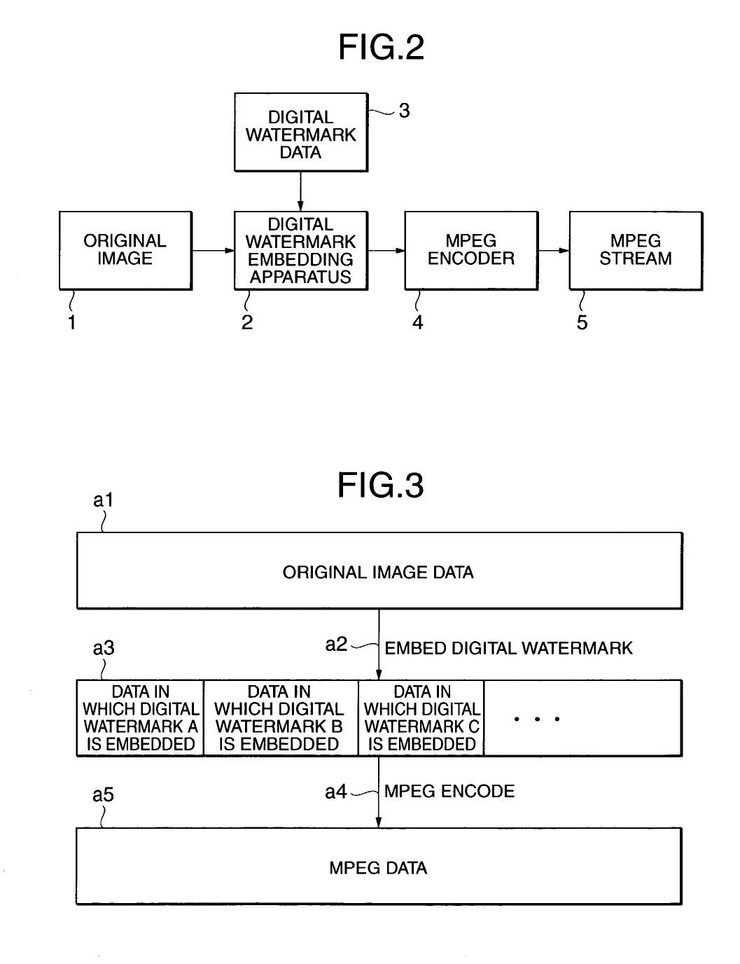

FIG. 2 is a block diagram showing an apparatus that embeds digital watermarks into original images and MPEG-compresses the images into which digital watermarks have been embedded. A service operator that distributes video data (hereinafter called digital contents) including audio and video data uses this apparatus to embed digital watermarks into digital contents. Referring to FIG. 2, a digital watermark embedding apparatus 2 embeds digital watermarks 3 into an original image 1. An MPEG encoder 4 receives the original image 1 containing the digital watermarks 3 and compresses it using the MPEG (Moving Picture Experts Group) format to generate an MPEG stream 5.

FIG. 3 is a diagram showing the configuration of data streams processed by the system according to the present invention. Referring to FIG. 3, a1 indicates a data stream of original image data, a3 indicates a data stream of image data into which digital watermarks are embedded, and a5 is a data stream of MPEG-compressed image data. Those data streams correspond to the components shown in FIG. 2 as follows. That is, the original image 1 corresponds to a1, the output data of the digital watermark embedding apparatus 2 corresponds to a3, and the MPEG stream 5 corresponds to a5, respectively. The original image data a1 is composed of multiple scenes or multiple chapters. Those multiple scenes or chapters each contain a separate digital watermark (digital watermarks A, digital watermarks B, digital watermarks C, etc.). The created MPEG data a5 is either distributed over the network or recorded on a recording medium such as a DVD (Digital Versatile Disc) and a CD-ROM.

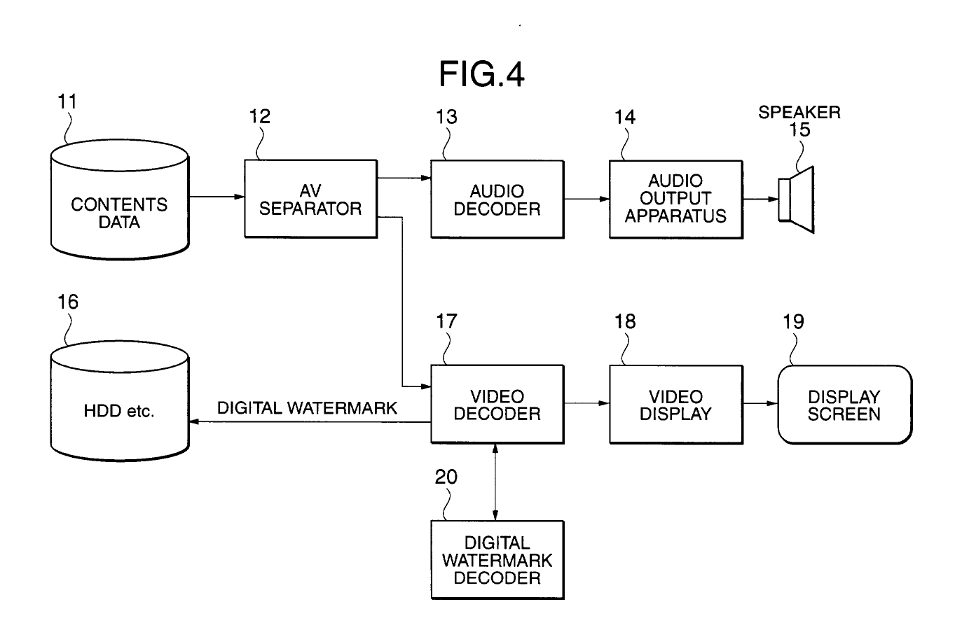

FIG. 4 is a block diagram showing the configuration of a digital contents data reproducer. Referring to FIG. 4, the digital contents data reproducer comprises digital contents data 11, an AV (Audio Video) separator 12, an audio decoder 13, an audio output apparatus 14, a speaker 15, a recording medium 16 such as an HDD (Hard Disk Drive), a video decoder 17, a video display 18, a display screen 19, and a digital watermark detector 20.

Next, the operation of the digital contents data reproducer will be described.

The AV separator 12 separates the digital contents data 11 into audio data and video data. The audio decoder 13 decodes the separated audio data. The audio output apparatus 14 outputs the decoded audio data to the speaker 15.

On the other hand, the video decoder 17 decodes the video data separated by the AV separator 12. The video display 18 displays the decoded video data on the display screen 19. The digital watermark detector 20 detects digital watermarks embedded in the video data while the video data is being decoded by the video decoder 17. The video decoder 17 records the detected digital watermarks on the recording medium 16 such as an HDD.

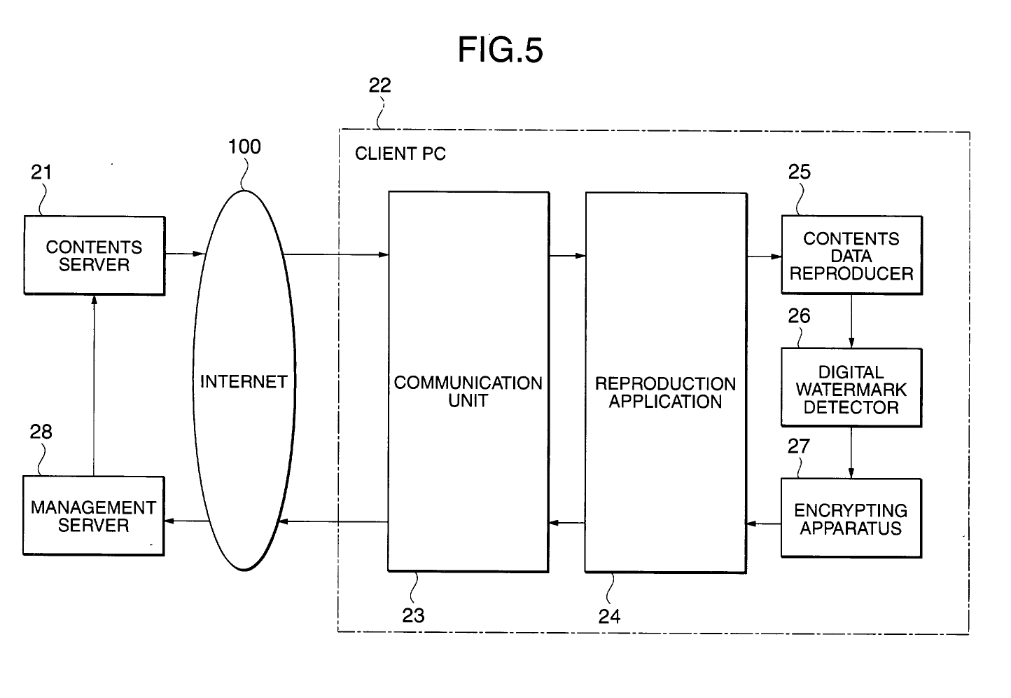

FIG. 5 is a block diagram showing the system configuration of a streaming distribution system. Referring to FIG. 5, the streaming distribution system comprises a contents server 21, a communication network 100 such as the Internet, a client PC (Personal Computer) 22, and a management server 28. The client PC 22 comprises a communication unit 23, a reproduction application 24, a digital contents data reproducer 25, a digital watermark detector 26, and an encrypting apparatus 27.

The contents server 21 stores digital contents data therein. The contents server 21 distributes the digital contents data to the client PC 22 over the communication network in real time.

The client PC 22 is an end user terminal such as a personal computer. The reproduction application 24 in the client PC 22 is a software product that reproduces distributed digital contents data. The digital watermark detector 26 detects digital watermarks contained in digital contents data. The encrypting apparatus 27 encrypts the digital watermarks detected by the digital watermark detector 26. The management server 28 controls the client PC 22 and the contents server 21.

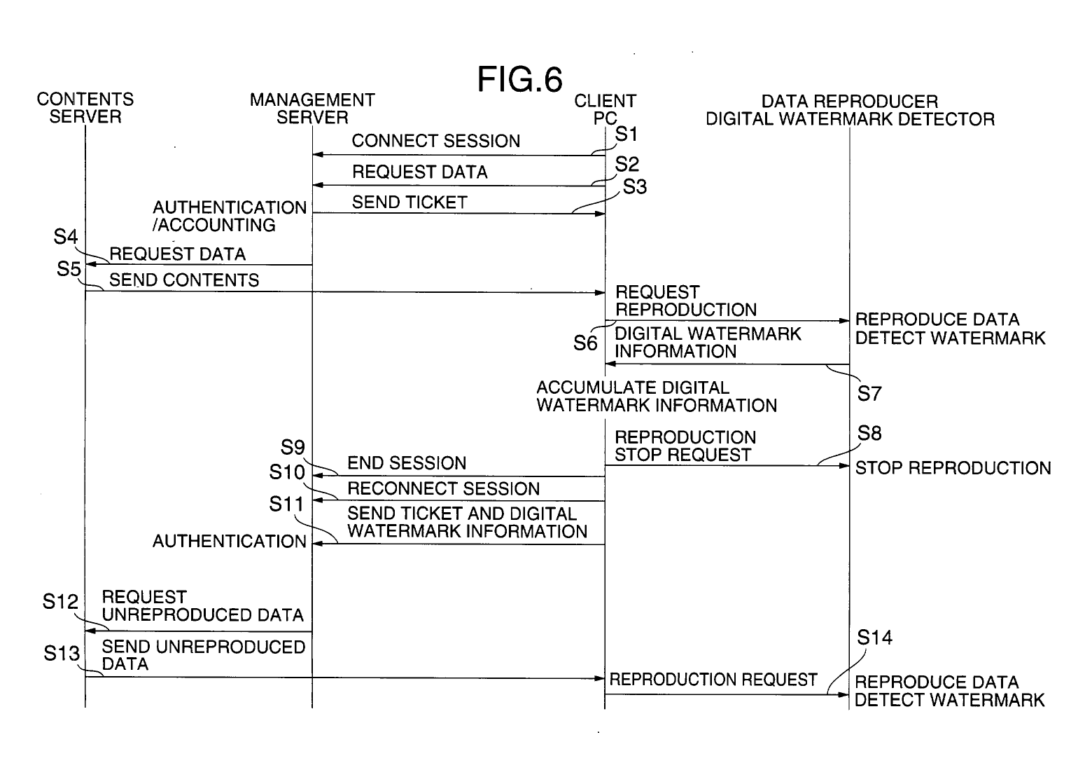

FIG. 6 is a sequence diagram showing the operation of a streaming distribution system in one embodiment of the present invention. With reference to FIGS. 2-6, the operation of the streaming distribution system according to the present invention will be described.

Referring to FIGS. 2 and 3, the digital watermark embedding apparatus 2 embeds digital watermarks (a2 in FIG. 3) into the original image 1 (a1 in FIG. 3). The digital watermarks to be embedded depend on scenes or chapters. Data into which digital watermarks have been embedded (a3 in FIG. 3) is MPEG-encoded (a4 in FIG. 3) by the MPEG encoder 4 into MPEG data (a5 in FIG. 3, MPEG stream 5 in FIG. 2).

Next, with reference to FIGS. 4-6, the operation of digital contents reproduction in one embodiment of the present invention will be described.

Referring to FIG. 6, the client PC 22 first sends a session connection request to the management server 28 (S1). When the connection is established, the client PC 22 requests the management server 28 to send data to be reproduced (S2). Next, the management server 28 performs user authentication and accounting processing and sends a ticket to the client PC 22 (S3). Next, the management server 28 requests the contents server 21 to send data requested by the client PC 22 (S4). In response to the request, the contents server 21 sends digital contents data to the client PC 22 (S5). Immediately after the client PC 22 starts receiving digital contents, the reproduction application 24 requests the digital contents data reproducer 25 to reproduce digital contents (S6). Referring to FIG. 4, the digital contents data reproducer 25 separates the received digital contents data 11 into audio data and video data with the use of the AV separator 12. Audio data separated by the AV separator 12 is decoded by the audio decoder 13 and, via the audio output apparatus 14, output to the speaker 15. Video data separated by the AV separator 12 is decoded by the video decoder 17. In parallel with the decoding operation, the digital watermark detector 20 detects the digital watermarks embedded in the digital contents. The video display 18 outputs the decoded video data on the display screen 19. The video decoder 17 encrypts the digital watermarks, which were detected by the digital watermark detector 20, and records the encrypted digital watermarks onto the recording medium 16 such as an HDD (S7). The digital watermarks are associated with the digital contents ticket and are recorded on the recording medium 16.

When the user issues an instruction to stop reproduction during digital contents reproduction, the digital contents data reproducer 25 stops reproduction (S8). Next, the client PC 22 sends a session end notification to the management server 28 (S9). At that time, the ticket and the encrypted digital watermarks are saved on the recording medium 16.

When the user issues an instruction to reproduce the remaining part of the digital contents, the session is reconnected (S10). When the session connection is established, the client PC 22 sends the ticket and the digital watermarks saved on the recording medium 16 to the management server 28 (S11).

The management server 28 authenticates the user using the received ticket and the digital watermarks and requests the contents server 21 to send the part of data not yet reproduced by the client PC 22 (S12). The contents server 21 sends the data requested by the management server 28 to the client PC 22 (S13). The client PC 22 reproduces the part not yet reproduced (S14).

In a digital contents distribution service such as a streaming service where digital contents are reproduced in real time, if the user stops the reproduction of purchased digital contents halfway for some reason and then requests to restart the reproduction of the same digital contents, the system according to the present invention can distribute the digital contents to be distributed, beginning with the scene where the reproduction was stopped, with no further accounting.

In addition, the client PC 22 has the function that sends as necessary the digital watermarks, which are detected during the reproduction of digital contents, to the management server 28 or contents server 21. This allows a digital-contents providing service operator to collect digital contents reproduction history. Using this history information, service operators that provide digital contents such as teaching materials or commercial messages are able to investigate the learning level of teaching materials or the audience rating of commercial messages.

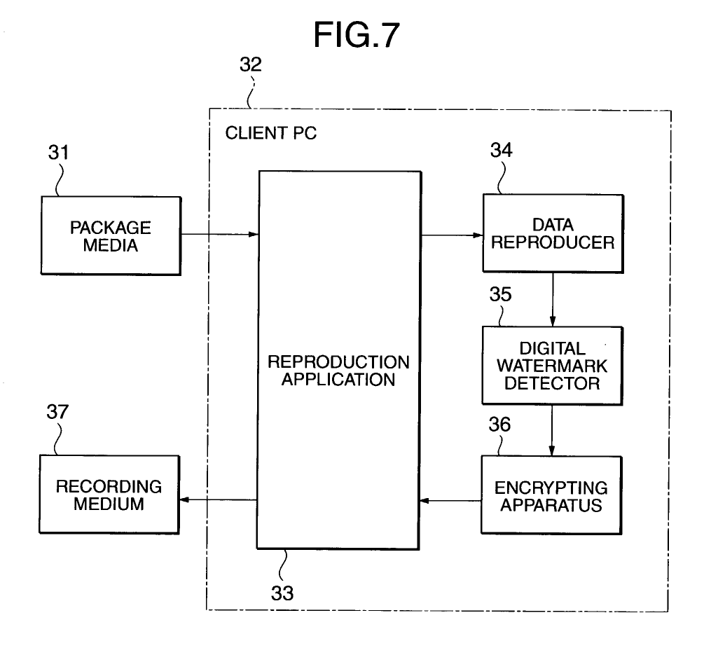

FIG. 7 is a block diagram of a digital contents distribution system in another embodiment of the present invention. Referring to FIG. 7, a digital contents distribution system in another embodiment of the present invention differs from the present invention described above in that a package medium 31 such as a CD-ROM or a DVD is used instead of the communication medium in the streaming distribution system.

Referring to FIG. 7, a reproduction application 33 in a client PC 32 reproduces digital contents stored in the package medium 31. As in the embodiment described above, a data reproducer 34 reproduces digital contents and a digital watermark detector 35 detects digital watermarks. An encrypting apparatus 36 encrypts the detected digital watermarks and, via the reproduction application 33, records the encrypted digital watermarks on a recording medium 37. The digital watermarks recorded on the recording medium 37, which are used, for example, as a learning record of teaching materials, are sent to digital contents provider such as schoolteachers. The received information may be used as the student's leaning records to understand the learning process of the individuals.

The present invention may also be applied to an advertising package medium. That is, by providing free package media 31 and receiving the digital watermarks via recording medium or communication means such as the Internet, the audience rating or the interest of end users may be investigated.

What is claimed is:

1. A contents server distributing digital contents composed of a plurality of scenes or a plurality of chapters to a client terminal, said contents server comprising:
means for embedding digital watermarks into the plurality of scenes and the plurality of chapters, said digital watermarks differing from scene to scene or from chapter to chapter; and
means for encoding the digital contents into which the digital watermarks have been embedded.

2. A client terminal reproducing digital contents composed of a plurality of scenes or a plurality of chapters, comprising:
detecting means for detecting digital watermarks embedded in the digital contents when the digital contents are reproduced; and
recording means for recording the digital watermarks detected by said detecting means when a reproduction of the digital contents is stopped.

3. The client terminal according to claim 2, wherein the digital contents are leaning materials and, based on the digital watermarks recorded on said recording means, a learning level of the leaning materials is investigated.

4. The client terminal according to claim 3, wherein said digital contents are advertisements and, based on the digital watermarks recorded on said recording means, an audience rating of the advertisements is investigated.

5. The contents server according to claim 1, wherein said digital contents are provided to said client terminal as streaming data.

6. The contents server according to claim 1, wherein said digital contents are stored in a package medium before being provided to said client terminal.

7. A digital contents distribution system comprising a contents server that distributes digital contents composed of a plurality of scenes or a plurality of chapters to a client terminal and the client terminal that reproduces the digital contents, wherein
said contents server comprises:
means for embedding digital watermarks into the plurality of scenes and the plurality of chapters, said digital watermarks differing from scene to scene or from chapter to chapter; and
means for encoding the digital contents into which the digital watermarks have been embedded, and
wherein said client terminal comprises:
detecting means for detecting digital watermarks embedded in the digital contents while the digital contents sent from said contents server are being reproduced; and
recording means for recording the digital watermarks when a reproduction of the digital contents is stopped, said digital watermarks being detected by said detecting means.

8. A digital contents distribution system comprising a contents server that distributes digital contents composed of a plurality of scenes or a plurality of chapters to a client terminal, the client terminal that reproduces the digital contents, and a management server that controls said contents server, wherein
said contents server comprises:
means for embedding digital watermarks into the plurality of scenes and the plurality of chapters, said digital watermarks differing from scene to scene or from chapter to chapter; and
means for encoding the digital contents into which the digital watermarks have been embedded,
wherein said client terminal comprises:
detecting means for detecting the digital watermarks embedded in the digital contents while the digital contents are being reproduced;
recording means for recording the digital watermarks detected by said detecting means; and
sending means for sending the digital watermarks detected by said detecting means to said management server, and
wherein said management server references the digital watermarks sent from said client terminal to control digital contents distribution performed by said contents server.

9. A digital contents distribution system comprising a contents server that distributes digital contents composed of a plurality of scenes or a plurality of chapters to a client terminal, the client terminal that reproduces the digital contents, and a management server that manages said contents server,
wherein said contents server comprises:
means for embedding digital watermarks into the plurality of scenes or the plurality of chapters, said digital watermarks differing from scene to scene or from chapter to chapter; and
means for encoding the digital contents into which the digital watermarks have been embedded,
wherein said client terminal comprises:
detecting means for detecting the digital watermarks embedded in the digital contents while the digital contents sent from said contents server are being reproduced; and
recording means for recording the digital watermarks detected by said detecting means when a reproduction of the digital contents is stopped; and
wherein said management server references the digital watermarks sent from said client terminal to instruct said contents server to distribute a part of the digital contents not yet reproduced.

10. The digital contents distribution system according to claim 8 or 9,
wherein said management server sends ticket data to said client terminal in response to a data request from said client terminal.

11. The digital contents distribution system according to claim 10, wherein said client terminal sends the ticket data as well as the digital watermarks to said management server.

12. A digital contents distribution method for distributing digital contents composed of a plurality of scenes or a plurality of chapters to a client terminal, said method comprising the steps of:
embedding digital watermarks into the plurality of scenes or the plurality of chapters, said digital watermarks differing from scene to scene or from chapter to chapter; and
encoding the digital contents into which the digital watermarks have been embedded.

13. A digital contents reproduction method for reproducing digital contents composed of a plurality of scenes or a plurality of chapters, said method comprising the steps of:
detecting digital watermarks embedded in the digital contents when the digital contents are reproduced; and
when a reproduction of the digital contents is stopped, recording the detected digital watermarks.

14. The digital contents reproduction method according to claim 13, wherein the digital contents are leaning materials and, based on the recorded digital watermarks, a learning level of the leaning materials is investigated.

15. The digital contents reproduction method according to claim 13, wherein said digital contents are advertisements and, based on the recorded digital watermarks, an audience rating of the advertisements is investigated.

16. The digital contents distribution method according to claim 12, wherein said digital contents are provided to said client terminal as streaming data.

17. The digital contents distribution method according to claim 12, wherein said digital contents are stored in a package medium before being provided to said client terminal.

18. A digital contents distribution/reproduction method for distributing and reproducing digital contents composed of a plurality of scenes or a plurality of chapters, said method comprising the steps of:
embedding digital watermarks into the plurality of scenes or the plurality of chapters, said digital watermarks differing from scene to scene or from chapter to chapter;
detecting the digital watermarks embedded in the digital contents while the digital contents in which the digital watermarks are embedded are being reproduced; and
when a reproduction of the digital contents is stopped, recording the detected digital watermarks.

19. A digital contents distribution/reproduction method for distributing and reproducing digital contents composed of a plurality of scenes or a plurality of chapters, said method comprising the steps of:
embedding digital watermarks into the plurality of scenes and the plurality of chapters, said digital watermarks differing from scene to scene or from chapter to chapter;
detecting the digital watermarks embedded in the digital contents white the digital contents in which the digital watermarks are embedded are being reproduced;
recording the detected digital watermarks; and
referencing the detected digital watermarks to control the distribution of the digital contents.

20. A digital contents distribution/reproduction method for distributing and reproducing digital contents composed of a plurality of scenes or a plurality of chapters, said method comprising the steps of:
embedding digital watermarks into the plurality of scenes or the plurality of chapters, said digital watermarks differing from scene to scene or from chapter to chapter;
detecting digital watermarks embedded in the digital contents while the digital contents in which the digital watermarks are embedded are being reproduced;
when a reproduction of the digital contents is stopped, recording the detected digital watermarks; and
referencing the detected digital watermarks to distribute a part of the digital contents not yet reproduced.
